(19) United States
(12) Patent Application Publication
(10) Pub. No.: US 2005/0175353 A1
(43) Pub. Date: Aug. 11, 2005

(54) Method and apparatus for two-port allpass compensation of polarization mode dispersion

(76) Inventor: Dennis R. Morgan, Morristown, NJ (US)

Correspondence Address: Ryan, Mason & Lewis, LLP, Suite 205, 1300 Post Road, Fairfield, CT, 06824, US

(21) Appl. No.: 10/775,911

(22) Filed: Feb. 10, 2004

(51) Int. Cl. H04B 10/12

(52) U.S. Cl. 398/149

(57) ABSTRACT

A method and apparatus are disclosed for compensating for polarization mode dispersion using cascaded all-pass filters and directional couplers. The disclosed PMD compensator adjusts the coefficients of an adaptive filter structure involving all-pass filters and directional couplers based on a minimized cost function. In one implementation, a stochastic gradient algorithm, also referred to as the least mean square algorithm, is employed to sequentially reduce the value of the cost function by the method of steepest descent. In one another implementation, convergence is improved by employing a Newton algorithm that uses second derivatives to accelerate convergence.

### FIELD OF THE INVENTION

The present invention relates generally to optical fiber transmission systems and, more particularly, to methods and apparatus for measuring and controlling polarization mode dispersion (PMD) in such optical fiber transmission systems.

### BACKGROUND OF THE INVENTION

Optical communication systems increasingly employ wavelength division multiplexing (WDM) techniques to transmit multiple information signals on the same fiber at different optical frequencies. WDM techniques are being used to meet the increasing demands for improved speed and bandwidth in optical transmission applications, including fiber optic communication systems.

Polarization mode dispersion (PMD) is a fundamental problem in single-mode fiber optic communication systems that has limited the channel capacity. Fiber asymmetry gives rise to random birefringence effects, resulting in differential group delay (DGD) between the two principle polarization modes. Wavelength dependent coupling of the modes then leads to polarization mode dispersion, which becomes the dominant limiting factor of transmission rate as bandwidth increases.

A need therefore exists for improved techniques for compensating for polarization mode dispersion in order to further improve the efficiency and channel capacity of high-speed fiber optic communication.

### SUMMARY OF THE INVENTION

Generally, a method and apparatus are disclosed for compensating for polarization mode dispersion using cascades of all-pass filters and directional couplers. The disclosed PMD compensator adjusts the coefficients of an adaptive filter structure involving all-pass filters and directional couplers based on a minimized cost function. In one implementation, a stochastic gradient algorithm, also referred to as the least mean square (LMS) algorithm, is employed to sequentially reduce the value of the cost function by the method of steepest descent. In another implementation, convergence is improved by employing a Newton algorithm that uses second derivatives to accelerate convergence.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram of a conventional optical receiver that employs a PMD compensator;

FIG. 2 is a schematic block diagram illustrating of a conventional optical fiber transmission system that employs a PMD compensator;

FIG. 3 is a schematic block diagram of the PMD measuring apparatus of FIG. 1;

FIG. 4 is a schematic block diagram of a polarization mode dispersion compensator for use in an optical receiver;

FIG. 5 illustrates an exemplary model of a PMD generator; and

FIG. 6 illustrates an exemplary model of a PMD compensator.

### DETAILED DESCRIPTION

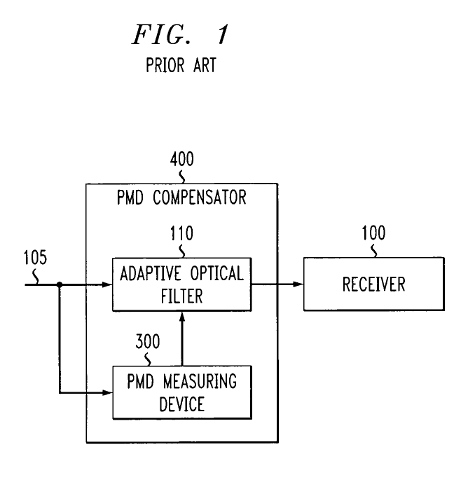

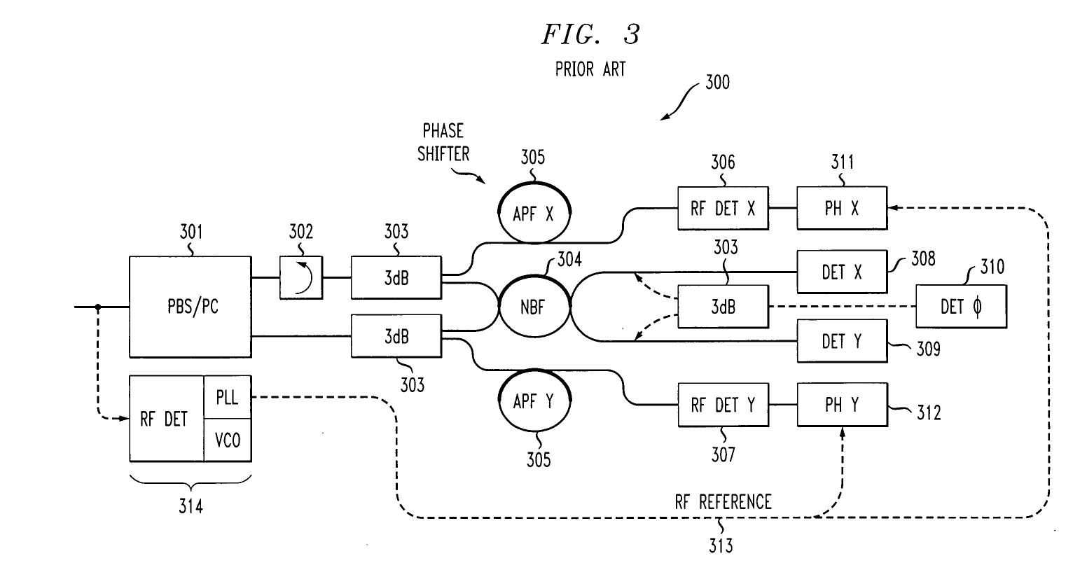

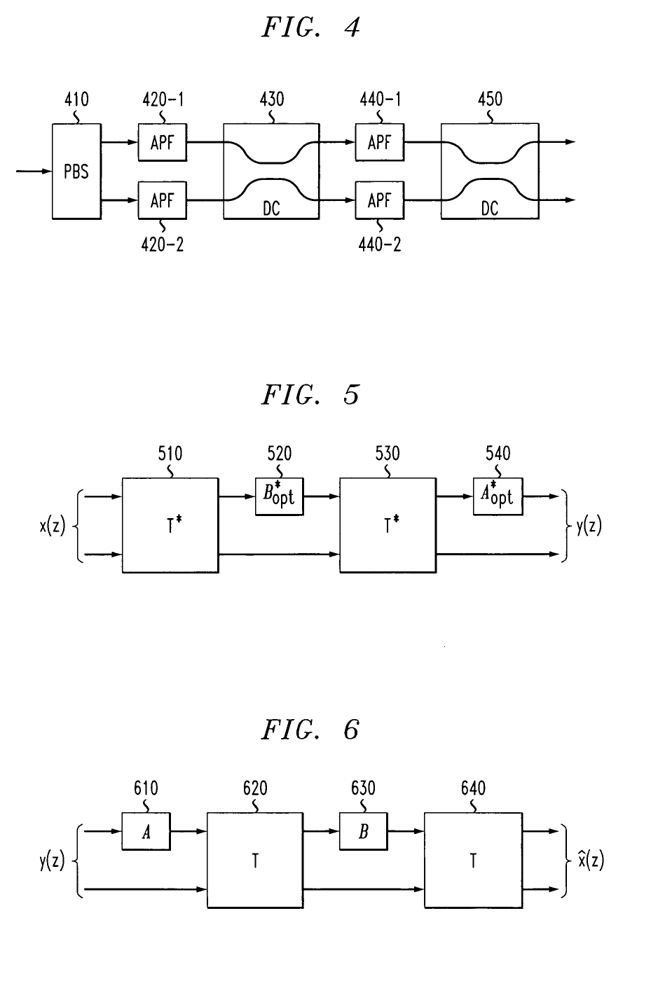

The present invention provides a method and apparatus for compensating for polarization mode dispersion using cascades of all-pass filters and directional couplers. The disclosed PMD compensator adjusts the coefficients of an adaptive filter structure involving all-pass filters and directional couplers based on a minimized cost function. Initially, the phase and amplitude of polarization components are evaluated in order to characterize the PMD of channels and adjust tunable PMD compensators. FIG. 1 is a schematic block diagram of a conventional optical receiver 100 that employs a PMD compensator 400, discussed below in conjunction with FIG. 4. Generally, the PMD compensator 400 employs a PMD measuring apparatus 300, discussed further below in conjunction with FIG. 3, to measure the PMD and an adaptive optical filter 110 to compensate for the measured PMD. The PMD compensator 400 may be integrated with or in the vicinity of the optical receiver 100.

As shown in FIG. 1, an information signal is received by the optical receiver 100 over an optical fiber 105. The PMD compensator 400 measures the phase and magnitude of the polarization components and generates a feedback signal for controlling one or more adaptive optical filters 300 to reduce polarization mode dispersion.

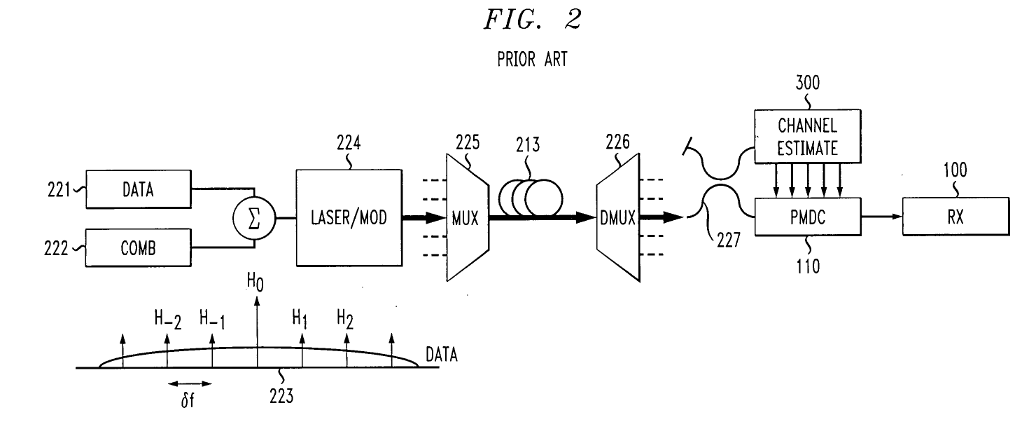

FIG. 2 is a schematic block diagram illustrating of a conventional optical fiber transmission system 200 that employs the PMD compensator 400. A test signal 222 is added to a data signal 221 in the form of a comb of tones with known relative magnitude and phase relationships. The tones can be equally spaced. The spacing a δf between the tones may be on the order of 2.5 to 5 GHz. The tones provide test signal information with a higher signal-to-noise ratio at the receiver than a pseudo-random bit sequence. There are many ways to add such a test signal 222, including modifying the data format such that tones with the desired frequency spacing appear in the output spectrum 223. The combined data signal and test signal is fed to a laser/modulator combination 224 to generate a wavelength channel (as a channel in a wavelength division multiplexed (WDM) transmission system). The channel is combined with other channels in an optical multiplexer 225 to form a composite light signal. The composite light signal is then transmitted via optical transmission path 213.

At a receiver, demultiplexer 226, preferably at the downstream end of optical transmission path 213, separates the wavelength channels. Optical coupler 227 provides a wavelength channel to the polarization mode dispersion compensator (PMDC) 110 (the adaptive optical filter). Coupler 227 also provides light to the PMD measuring apparatus 300. The channel estimate made at PMD measuring apparatus 300 generates an adaptive PMD correction signal to control PMDC 110. Receiver (RX) 100 receives the compensated wavelength channel signal. The RF detectors (not shown in FIG. 2) of the channel estimate signal analyzer 300 need only have enough bandwidth to accommodate δf and not the whole signal bandwidth. The problem is to determine the relative phase between each pair of tones when they are all present at the detector.

FIG. 3 schematically illustrates an exemplary PMD measuring apparatus 300 for analyzing the test signal downstream. Each polarization is split into a separate path by a polarization beam splitter (PBS) and polarization controller (PC) 301. The PC 301 allows the power in the x- and y-outputs to be controlled so that all of the power is not in one output or the other. One polarization of the output of the PBS/PC is flipped by a 90 degree rotation 302 so that the outputs going into the 3 dB couplers 303 have the same polarization, i.e., either TE or TM. After the 3 dB coupler, one portion of each polarization is analyzed by a tunable narrowband filter (NBF) 304 to obtain the magnitude across the channel (detectors X 308, Y 309), and φ the relative phase between polarization (detector 310) derived via 3 dB coupler 303, while the other portion is transmitted through a tunable all-pass filter (APF) 305 before being detected.

Both polarizations see the same narrowband filter but in counterpropagating directions. The filters are tuned, for example, by thermo-optic phase shifters. The APF's are identical in principle, but any variations can be handled by calibration. Each APF is designed to provide a very sharp transition in its phase response from 0 to 2π near resonance. On-resonance, the phase is π. Off-resonance, the phase is ideally 0 or 2π. As the resonant frequency is shifted via a phase shifter in the feedback path, the phase response is translated across the channel spectrum and the RF detectors X 306 and Y 307 record different linear combinations of beats between adjacent tones. An RF reference 313 is obtained from a light signal tapped before the polarization beam splitter 301 and fed to an RF detector and phase locked loop incorporating a voltage controlled oscillator 314 to develop an RF reference signal 313. Blocks 311 and 312 measure the phase of the X and Y components as detected by 306 and 307 with respect to the RF reference 313. For a detailed discussion of the PMD measuring apparatus 300, see U.S. patent application Ser. No. 10/180,842, entitled “Apparatus and Method for Measurement and Adaptive Control of Polarization Mode Dispersion in Optical Fiber Transmission Systems,” incorporated by reference herein.

According to another aspect of the invention, adaptive algorithms are provided for two-channel (two-input/two-output) structures consisting of multiple cascades of all-pass filters and directional couplers. While this exemplary architecture is employed for compensation of polarization mode dispersion, the results apply more generally to this class of filters, as would be apparent to a person of ordinary skill in the art. For a detailed discussion of an application of this architecture to PMD compensation using multiple cascades of all-pass filters and directional couplers, see C. K. Madsen, “Optical All-Pass Filters for Polarization Mode Dispersion Compensation,” Optics Letters, Vol. 25, No. 12, 878-80 (June, 2000), incorporated by reference herein.

FIG. 4 is a schematic block diagram of a conventional polarization mode dispersion compensator 400 for use in an optical receiver, such as the optical receiver 100 of FIG. 1. As shown in FIG. 4, the PMD compensator 400 is a two-channel (two-input/two-output) structure consisting of multiple cascades of all-pass filters and directional couplers. In particular, the PMD compensator 400 includes a polarization beam splitter 410, two pair of multistage all-pass filters 420-1, 420-2, 440-1, 440-2 and two directional couplers 430, 450, that all operate in a known manner.

Models for PMD Generation and Compensation FIG. 5 illustrates an exemplary model of a PMD generator, where the two dimensional polarization z-transform vector x(z) generated by the transmitter produces the fiber output polarization vector y(z) at the receiver. Aₒₚₜ 540 and Bₒₚₜ 520 are multistage all-pass filters and

$$T = \frac{\sqrt{2}}{2} ( \begin{matrix}1 & - j \\ - j & 1\end{matrix} ) \qquad ( 1 )$$

is a unitary matrix representing a directional coupler 510, 530 with parameter value 0.5 and j=\sqrt{−1}. In this manner, the simplified PMD compensator 600 of FIG. 6 has the ideal capability of complete compensation, i.e., the compensator output \hat{x}(z)=x(z), when A=Aₒₚₜ and B=Bₒₚₜ. This will allow observations about the behavior of parameter estimation algorithms to be made without being overly burdened by the complications of real PMD.

The multistage all-pass filter A 540 is mathematically expressed as:

$$A ( z ) = {\prod }_{p = 1}^{P} {A}_{p} ( z ) , \qquad ( 2 )$$

where P is the number of stages and the response of each stage is written as follows:

$${A}_{p} ( z ) = \frac{{z}^{- 1} - {a}_{p}^{*}}{1 - {a}_{p} {z}^{- 1}} , \qquad ( 3 )$$

where aₚ is a complex number that specifies the pole location and * denotes complex conjugate. (The complementary zero location is at 1/a*ₚ.) The sections Aₚ(z) are all-pass functions so that |Aₚ(Z)|=1 at all frequencies.

Likewise, a Q-stage filter B 520 is defined as

$$B ( z ) = {\prod }_{q = 1}^{Q} {B}_{q} ( z ) , \qquad ( 4 )$$

where Q is the number of stages and the response of each stage is written as follows:

$${B}_{q} ( z ) = \frac{{z}^{- 1} - {b}_{q}^{*}}{1 - {b}_{q} {z}^{- 1}} \qquad ( 5 )$$

Cascading the above in the order of FIG. 5 and multiplying out the 2×2 matrices gives the overall response of the PMD model:

$$y = \frac{1}{2} [ \begin{matrix}{A}_{opt}^{*} ( {B}_{opt}^{*} - 1 ) & {jA}_{opt}^{*} ( {B}_{opt}^{*} + 1 ) \\ j ( {B}_{opt} + 1 ) & - ( {B}_{opt}^{*} - 1 )\end{matrix} ] x \qquad ( 6 )$$

This shows how the input polarization signals are coupled to the output signals, as determined by the all-pass model filters Aₒₚₜ 540 and Bₒₚₜ 520. When Aₒₚₜ=Bₒₚₜ=−1, y=x and there is no distortion.

Now consider the response of the PMD compensator 600 of FIG. 6, which is similarly calculated as:

$$\hat{x} = \frac{1}{2} [ \begin{matrix}A ( B - 1 ) & - j ( B + 1 ) \\ - jA ( B + 1 ) & - ( B - 1 )\end{matrix} ] y . \qquad ( 7 )$$

Again, note that \hat{x}=y for A=B=−1. Also note that for A=Aₒₚₜ and B=Bₒₚₜ, the matrices in Equations (6) and (7) are conjugate transpose pairs; in fact, it can be easily demonstrated that in this case they are unitary so that their product is the identity matrix and \hat{x}=x. Thus, the compensator completely removes the modeled PMD for A=Aₒₚₜ and B=Bₒₚₜ.

The difference between the ideal input signal vector x and its recovered estimate \hat{x} forms an error signal vector
e(z)=x(z)−\hat{x}(z) (8)
which should be small. In other words, the error signal vector, e(z), (having two values, one for each principle polarization mode) characterizes the difference between the signal that was transmitted, x(z), (which is known) and the response, \hat{x}(z), of the PMD compensator. Here, it is assumed that compensation is performed over a discrete set of K representative frequencies zₖ, k=1, . . . , K, and form the weighted cost function:

$$J = {\sum }_{k = 1}^{K} [ {λ}_{1} {\vert {e}_{1} ( {z}_{k} ) \vert}^{2} + {λ}_{2} {\vert {e}_{2} ( {z}_{k} ) \vert}^{2} ] . \qquad ( 9 )$$

Equation (9) looks at the two components of the error signal vector, e(z), as functions of frequency (zₖ). Generally, Equation (9) determines a weighted sum of the squared error, that is summed over K frequencies.

As discussed hereinafter, the present invention provides adaptive algorithms for adjusting A and B to minimize this cost function, J. The complex (amplitude and phase) measurements of the optical PMD compensator output \hat{x} for each frequency zₖ are provided by the detector 310 of FIG. 3. Generally, such measurements can be obtained using a tunable narrowband optical filter and various other optical components to render information from energy detector measurements. For a more detailed discussion of the detector 310 for measuring the complex (amplitude and phase) measurements of the optical PMD compensator output x for each frequency zₖ, see U.S. patent application Ser. No. 10/180,842, entitled “Apparatus and Method for Measurement and Adaptive Control of Polarization Mode Dispersion in Optical Fiber Transmission Systems,” incorporated by reference herein.

### Adaptive Algorithms

According to another aspect of the invention, two exemplary algorithms are presented for adapting the coefficients of a two-channel adaptive filter structure involving two all-pass filters and two directional couplers. Both exemplary adaptive algorithms minimize the cost function of equation (9). The first adaptive algorithm is a stochastic gradient algorithm, also referred to as the least mean square algorithm, and sequentially reduces the value of J by the method of steepest descent. For the simplified model of FIGS. 5 and 6, the effects of random signals or noise are not considered, so the LMS algorithm in this case operates on deterministic signals (thus, the LMS algorithm is not really forming a stochastic gradient).

As is well known, the LMS algorithm has the disadvantage of slow convergence for some applications in which the effect of the adjustable coefficients is closely coupled. As shown hereinafter, such behavior results for the all-pass PMD compensation context of the present invention. Therefore, a Newton algorithm is also derived for this application that makes use of second derivatives to accelerate convergence. For both algorithms, it will be necessary to calculate derivatives of the error signals e₁ and e₂ in (9).

LMS Algorithm

The LMS algorithm adapts the (complex) coefficients of the PMD compensator all-pass filters employed by equations (3) and (5) as follows:

$$\begin{matrix}{a}_{p} ( n + 1 ) = {a}_{p} ( n ) - μ \frac{\partial J}{\partial {a}_{p}} & ( 10 a ) \\ {b}_{q} ( n + 1 ) = {b}_{q} ( n ) - μ \frac{\partial J}{\partial {b}_{q}} & ( 10 b )\end{matrix}$$

where μ is the step size and

$$\frac{\partial J}{\partial c}$$

denotes the complex derivative of J with respect to the complex variable c, defined as:

$$\frac{\partial J}{\partial c} = \frac{\partial }{\partial ℜ ( c )} + j \frac{\partial }{\partial 𝔍 ( c )} , \qquad ( 11 )$$

where R(c) and F(c) are, respectively, the real and imaginary parts of c=R(c)+jF(c).

As previously indicated, these updates are deterministic for the simplified model. However, in the case of random signals, this also provides instantaneous gradient updates which are subsequently smoothed by the recursive nature of the algorithm, as controlled by the selection of u. In general, the selection of step size value must take into account the competing objectives of rapid convergence/tracking, and maintaining stability (and smoothing in the case of random signals).

Differentiating equation (9) with respect to aₚ, it can be shown that:

$$\begin{matrix}\frac{\partial J}{\partial {a}_{p}^{r}} = 2 {\sum }_{k = 1}^{K} 𝔍 [ {G}_{p} ( {z}_{k} ) ] {F}_{1} ( {z}_{k} ) & ( 12 a ) \\ \frac{\partial J}{\partial {a}_{p}^{i}} = 2 {\sum }_{k = 1}^{K} ℜ [ {G}_{p} ( {z}_{k} ) ] {F}_{1} ( {z}_{k} ) , & ( 12 b )\end{matrix}$$

where aₚ^{r} and aₚⁱ are, respectively, the real and imaginary parts of aₚ=aₚ^{r}+jdₚⁱ,

$$\begin{matrix}{G}_{p} ( z ) ≡ ( \frac{1}{z - {a}_{p}} ) , \\ and & ( 13 ) \\ {F}_{1} ( z ) ≡ {λ}_{1} 𝔍 \{ A ( z ) [ B ( z ) - 1 ] {y}_{1} ( z ) {e}_{1}^{*} ( z ) \} - {λ}_{2} ℜ \{ A ( z ) [ B ( z ) + 1 ] {y}_{1} ( z ) {e}_{2}^{*} ( z ) \} & ( 14 )\end{matrix}$$

is a real valued function, independent of the index p. Combining equations (12a) and (12b), the complex derivative can be more compactly written as

$$\frac{\partial J}{\partial {a}_{p}} = j2 {\sum }_{k = 1}^{K} {G}_{p}^{*} ( {z}_{k} ) {F}_{1} ( {z}_{k} ) . \qquad ( 15 )$$

The complex derivative can be alternatively calculated by considering aₚ and a*ₚ to be independent variables and differentiating with respect to a*ₚ. However, the derivatives are separately derived with respect to the real and imaginary parts of aₚ because they will be needed in the next section to calculate the second derivatives.

Likewise, for B, the following is obtained:

$$\begin{matrix}\frac{\partial J}{\partial {b}_{p}^{r}} = 2 {\sum }_{k = 1}^{K} 𝔍 [ {H}_{q} ( {z}_{k} ) ] {F}_{2} ( {z}_{k} ) & ( 16 a ) \\ \frac{\partial J}{\partial {b}_{q}^{i}} = 2 {\sum }_{k = 1}^{K} ℜ [ {H}_{q} ( {z}_{k} ) ] {F}_{2} ( {z}_{k} ) \\ where & ( 16 b ) \\ {H}_{q} ( z ) ≡ ( \frac{1}{z - {b}_{q}} ) \\ and & ( 17 ) \\ {F}_{2} ( z ) ≡ {λ}_{1} 𝔍 \{ B ( z ) [ A ( z ) {y}_{1} ( z ) - {jy}_{2} ( z ) {e}_{1}^{*} ( z ) \} - {λ}_{2} ℜ \{ B ( z ) [ A ( z ) {y}_{1} ( z ) - {jy}_{2} ( z ) {e}_{2}^{*} ( z ) \} , \\ and & ( 18 ) \\ \frac{\partial J}{\partial {b}_{q}} = j2 {\sum }_{k = 1}^{K} {H}_{q}^{*} ( {z}_{k} ) {F}_{2} ( {z}_{k} ) . & ( 19 )\end{matrix}$$

A composite coefficient vector is defined as:

$$w = [ \begin{matrix}a \\ b\end{matrix} ] \qquad ( 20 )$$

where a≡[a₁ a₂ . . . aₚ]^{T} and b≡[b₁ b₂ . . . b_{Q}]^{T}, then equation (10) can be compactly written as:

$$\begin{matrix}w ( n + 1 ) = w ( n ) - μ Δ ( J ) , \\ where & ( 21 ) \\ ∇ ( J ) ≡ {[ \frac{\partial J}{\partial {a}^{T}} \frac{\partial J}{\partial {b}^{T}} ]}^{T} . & ( 22 )\end{matrix}$$

is the (P+Q)×1 complex gradient of J with respect to w, and

$$\begin{matrix}\frac{\partial J}{\partial {a}^{T}} ≡ [ \frac{\partial J}{\partial {a}_{1}} \frac{\partial J}{\partial {a}_{2}} ⋯ \frac{\partial J}{\partial {a}_{p}} ] & ( 23 a ) \\ \frac{\partial J}{\partial {B}^{T}} ≡ [ \frac{\partial J}{\partial {b}_{1}} \frac{\partial J}{\partial {b}_{2}} ⋯ \frac{\partial J}{\partial {b}_{Q}} ] & ( 23 b )\end{matrix}$$

It has been observed that the LMS algorithm demonstrates slow convergence, which can be solved using the Newton algorithm to accelerate convergence, discussed hereinafter.

Newton Algorithm

Newton's method involves multiplying the gradient by the inverse matrix of second derivatives, or Hessian. It has been found that it is not generally possible to apply this to the complex LMS algorithm defined by equation (21), whereby the Hessian is a complex matrix, even in the simplest case with a single complex coefficient. Therefore, the real and imaginary components of the weight update, as in equations (12) and (16), must be dealt with separately.

Taking second derivatives of equation (9) with respect to the real and imaginary parts of aₚ and bₚ, it can be shown that:

$$\begin{matrix}\frac{{\partial }^{2} J}{\partial {a}_{q}^{r} \partial {a}_{p}^{r}} = 2 {\sum }_{k = 1}^{K} \{ 𝔍 [ {G}_{q} ( {z}_{k} ) ] 𝔍 [ {G}_{p} ( {z}_{k} ) ] {G}_{11} ( {z}_{k} ) + 𝔍 [ {G}_{p}^{2} ( {z}_{k} ) ] {F}_{1} ( {z}_{k} ) {δ}_{pq} \} & ( 24 a ) \\ \frac{{\partial }^{2} J}{\partial {a}_{q}^{i} \partial {a}_{p}^{r}} = 2 {\sum }_{k = 1}^{K} \{ ℜ [ {G}_{q} ( {z}_{k} ) ] 𝔍 [ {G}_{p} ( {z}_{k} ) ] {G}_{11} ( {z}_{k} ) + ℜ [ {G}_{p}^{2} ( {z}_{k} ) ] {F}_{1} ( {z}_{k} ) {δ}_{pq} \} & ( 24 b ) \\ \frac{{\partial }^{2} J}{\partial {a}_{q}^{i} \partial {a}_{p}^{i}} = 2 {\sum }_{k = 1}^{K} \{ ℜ [ {G}_{q} ( {z}_{k} ) ] ℜ [ {G}_{p} ( {z}_{k} ) ] {G}_{11} ( {z}_{k} ) - 𝔍 [ {G}_{p}^{2} ( {z}_{k} ) ] {F}_{1} ( {z}_{k} ) {δ}_{pq} \} & ( 24 c ) \\ \frac{{\partial }^{2} J}{\partial {b}_{q}^{r} \partial {b}_{p}^{r}} = 2 {\sum }_{k = 1}^{K} \{ 𝔍 [ {H}_{q} ( {z}_{k} ) ] 𝔍 [ {H}_{p} ( {z}_{k} ) ] {G}_{22} ( {z}_{k} ) + 𝔍 [ {H}_{p}^{2} ( {z}_{k} ) ] {F}_{1} ( {z}_{k} ) {δ}_{pq} \} & ( 25 a ) \\ \frac{{\partial }^{2} J}{\partial {b}_{q}^{i} \partial {b}_{p}^{r}} = 2 {\sum }_{k = 1}^{K} \{ ℜ [ {H}_{q} ( {z}_{k} ) ] 𝔍 [ {H}_{p} ( {z}_{k} ) ] {G}_{22} ( {z}_{k} ) + ℜ [ {H}_{p}^{2} ( {z}_{k} ) ] {F}_{1} ( {z}_{k} ) {δ}_{pq} \} & ( 25 b ) \\ \frac{{\partial }^{2} J}{\partial {b}_{q}^{i} \partial {b}_{p}^{i}} = 2 {\sum }_{k = 1}^{K} \{ ℜ [ {H}_{q} ( {z}_{k} ) ] ℜ [ {H}_{p} ( {z}_{k} ) ] {G}_{22} ( {z}_{k} ) - 𝔍 [ {H}_{p}^{2} ( {z}_{k} ) ] {F}_{1} ( {z}_{k} ) {δ}_{pq} \} & ( 25 c ) \\ \frac{{\partial }^{2} J}{\partial {b}_{q}^{r} \partial {a}_{p}^{r}} = \frac{{\partial }^{2} J}{\partial {a}_{p}^{r} \partial {b}_{q}^{r}} = 2 {\sum }_{k = 1}^{K} 𝔍 [ {H}_{q} ( {z}_{k} ) ] 𝔍 [ {G}_{q} ( {z}_{k} ) ] {G}_{12} ( {z}_{k} ) & ( 26 a ) \\ \frac{{\partial }^{2} J}{\partial {b}_{q}^{i} \partial {a}_{p}^{r}} = \frac{{\partial }^{2} J}{\partial {a}_{p}^{r} \partial {b}_{q}^{i}} = 2 {\sum }_{k = 1}^{K} ℜ [ {H}_{q} ( {z}_{k} ) ] 𝔍 [ {G}_{q} ( {z}_{k} ) ] {G}_{12} ( {z}_{k} ) & ( 26 b ) \\ \frac{{\partial }^{2} J}{\partial {b}_{q}^{r} \partial {a}_{p}^{i}} = \frac{{\partial }^{2} J}{\partial {a}_{p}^{i} \partial {b}_{q}^{r}} = 2 {\sum }_{k = 1}^{K} 𝔍 [ {H}_{q} ( {z}_{k} ) ] ℜ [ {G}_{q} ( {z}_{k} ) ] {G}_{12} ( {z}_{k} ) & ( 26 c ) \\ \frac{{\partial }^{2} J}{\partial {b}_{q}^{i} \partial {a}_{p}^{i}} = \frac{{\partial }^{2} J}{\partial {a}_{p}^{i} \partial {b}_{q}^{i}} = 2 {\sum }_{k = 1}^{K} ℜ [ {H}_{q} ( {z}_{k} ) ] ℜ [ {G}_{q} ( {z}_{k} ) ] {G}_{12} ( {z}_{k} ) , & ( 26 d )\end{matrix}$$

where Gₚ and H_{q} are defined, respectively, in (13) and (17), δ_{pq}=1 for p−q and 0 otherwise, and

$$\begin{matrix}{G}_{11} ( z ) ≡ {λ}_{1} ℜ \{ 2 A ( z ) [ B ( z ) - 1 ] {y}_{1} ( z ) {e}_{1}^{*} ( z ) + {\vert [ B ( z ) - 1 ] {y}_{1} ( z ) \vert}^{2} \} + \\ {λ}_{1} 𝔍 \{ 2 A ( z ) [ B ( z ) + 1 ] {y}_{1} ( z ) {e}_{2}^{*} ( z ) + j {\vert [ B ( z ) + 1 ] {y}_{1} ( z ) \vert}^{2} \} & ( 27 a ) \\ {G}_{22} ( z ) ≡ {λ}_{1} ℜ \{ 2 B ( z ) [ A ( z ) {y}_{1} ( z ) - {jy}_{2} ( z ) ] {e}_{1}^{*} ( z ) + {\vert A ( z ) {y}_{1} ( z ) - j {y}_{2} ( z ) \vert}^{2} \} + \\ {λ}_{2} 𝔍 \{ 2 B ( z ) [ A ( z ) {y}_{1} ( z ) - {jy}_{2} ( z ) ] {e}_{2}^{*} ( z ) + j {\vert A ( z ) {y}_{1} ( z ) - {jy}_{2} ( z ) \vert}^{2} \} & ( 27 b ) \\ {G}_{12} ( z ) ≡ {λ}_{1} ℜ \{ 2 A ( z ) B ( z ) {y}_{1} ( z ) {e}_{1}^{*} ( z ) + A * ( z ) B ( z ) [ B * ( z ) - 1 ] [ A ( z ) {y}_{1} ( z ) - {jy}_{2} ( z ) ] {y}_{1}^{*} ( z ) \} + \\ {λ}_{1} 𝔍 \{ 2 A ( z ) B ( z ) {y}_{1} ( z ) {e}_{2}^{*} ( z ) + j A * ( z ) B ( z ) [ B * ( z ) + 1 ] [ A ( z ) {y}_{1} ( z ) - {jy}_{2} ( z ) ] {y}_{1}^{*} ( z ) \} & ( 27 c )\end{matrix}$$

are real functions.

It is noted that as e₁→0 and e₂→0, G₁₁ and G₂₂ are non-negative, and F₁→0 and F₂→0. Therefore, as the error goes to zero, equations (24) and (25) show that the diagonal terms

$$\frac{{\partial }^{2} J }{\partial {a}_{p}^{r} \partial {a}_{p}^{r}} \frac{{\partial }^{2} J }{\partial {a}_{p}^{i} \partial {a}_{p}^{r}} \frac{{\partial }^{2} J }{\partial {b}_{q}^{r} \partial {b}_{q}^{r}} \frac{{\partial }^{2} J }{\partial {b}_{q}^{i} \partial {b}_{q}^{i}} \qquad ( 28 )$$

are all non-negative, thus establishing a quadratic minimum.

The P×P Hessian sub-matrix is now assembled from equation (24a) as

$$\frac{{\partial }^{2} J }{\partial {a}^{r} \partial {a}^{{r}^{T}}} = [ \begin{matrix}\frac{{\partial }^{2} J }{\partial {a}_{1}^{r} \partial {{a}^{r}}_{2}^{T}} & \frac{{\partial }^{2} J }{\partial {a}_{1}^{r} \partial {a}_{2}^{{r}^{T}}} & ⋯ & \frac{{\partial }^{2} J }{\partial {a}_{1}^{r} \partial {a}_{P}^{{r}^{T}}} \\ \frac{{\partial }^{2} J }{\partial {a}_{2}^{r} \partial {a}_{1}^{{r}^{T}}} & \frac{{\partial }^{2} J }{\partial {a}_{2}^{r} \partial {a}_{2}^{{r}^{T}}} & ⋯ & \frac{{\partial }^{2} J }{\partial {a}_{2}^{r} \partial {a}_{p}^{{r}^{T}}} \\ ⋮ & ⋮ & ⋰ & ⋮ \\ \frac{{\partial }^{2} J }{\partial {a}_{p}^{r} \partial {a}_{1}^{{r}^{T}}} & \frac{{\partial }^{2} J }{\partial {a}_{p}^{r} \partial {a}_{2}^{{r}^{T}}} & ⋯ & \frac{{\partial }^{2} J }{\partial {a}_{p}^{r} \partial {a}_{p}^{{r}^{T}}}\end{matrix} ] \qquad ( 29 )$$

Likewise,

$$\frac{{\partial }^{2} J }{\partial {a}^{i} \partial {a}^{{i}^{T}}} and \frac{{\partial }^{2} J }{\partial {a}^{r} \partial {a}^{{i}^{T}}} = \frac{{\partial }^{2} J }{\partial {a}^{i} \partial {a}^{{r}^{T}}}$$

are formed. Then, defining the 2P×1 coefficient vector as:

$$a ≡ [ \begin{matrix}{a}^{r} \\ {a}^{i}\end{matrix} ] \qquad ( 30 )$$

where a^{r}≡[a₁^{r} a₂^{r} . . . aₚ^{r}] and aⁱ≡[a₁ⁱ a₂ⁱ . . . aₚⁱ], we form the 2P×2P Hessian matrix:

$$\frac{{\partial }^{2} J }{\partial a \partial {a}^{T}} = [ \begin{matrix}\frac{{\partial }^{2} J }{\partial {a}^{r} \partial {a}^{{r}^{T}}} & \frac{{\partial }^{2} J }{\partial {a}^{r} \partial {a}^{{i}^{T}}} \\ \frac{{\partial }^{2} J }{\partial {a}^{i} \partial {a}^{{r}^{T}}} & \frac{{\partial }^{2} J }{\partial {a}^{i} \partial {a}^{{i}^{T}}}\end{matrix} ] . \qquad ( 31 )$$

Similarly, from equations (25) and (26), the 2Q×2Q matrix is obtained as follows:

$$\frac{{\partial }^{2} J }{\partial b \partial {b}^{T}} = [ \begin{matrix}\frac{{\partial }^{2} J }{\partial {b}^{r} \partial {b}^{{r}^{T}}} & \frac{{\partial }^{2} J }{\partial {b}^{r} \partial {b}^{{i}^{T}}} \\ \frac{{\partial }^{2} J }{\partial {b}^{i} \partial {b}^{{r}^{T}}} & \frac{{\partial }^{2} J }{\partial {b}^{i} \partial {b}^{{i}^{T}}}\end{matrix} ] \qquad ( 32 )$$

and the 2Q×2P matrix is expressed as follows:

$$\begin{matrix}\frac{{\partial }^{2} J }{\partial b \partial {a}^{T}} = {[ \frac{{\partial }^{2} J }{\partial a \partial {b}^{T}} ]}^{T} = [ \begin{matrix}\frac{{\partial }^{2} J }{\partial {b}^{r} \partial {a}^{{r}^{T}}} & \frac{{\partial }^{2} J }{\partial {b}^{r} \partial {a}^{{i}^{T}}} \\ \frac{{\partial }^{2} J }{\partial {b}^{i} \partial {a}^{{r}^{T}}} & \frac{{\partial }^{2} J }{\partial {b}^{i} \partial {a}^{{i}^{T}}}\end{matrix} ] \\ where & ( 33 ) \\ b ≡ [ \begin{matrix}{b}^{r} \\ {b}^{i}\end{matrix} ] . & ( 34 )\end{matrix}$$

The above results are consolidated and the Newton algorithm is then formulated. First, a composite real coefficient vector is defined as follows:

$$w ≡ {[ \begin{matrix}{a}^{rT} & {a}^{{i}^{T}} & {b}^{rT} & {b}^{iT}\end{matrix} ]}^{T} = [ \begin{matrix}a \\ b\end{matrix} ] \qquad ( 35 )$$

and the composite (2P+2Q)×(2P+2Q) Hessian matrix is formed as follows:

$$H = \frac{{\partial }^{2} J}{\partial w \partial {w}^{T}} = [ \begin{matrix}\frac{{\partial }^{2} J }{\partial a \partial {a}^{T}} & \frac{{\partial }^{2} J }{\partial a \partial {b}^{T}} \\ \frac{{\partial }^{2} J }{\partial b \partial {a}^{T}} & \frac{{\partial }^{2} J }{\partial b \partial {b}^{T}}\end{matrix} ] . \qquad ( 36 )$$

Similarly, using equations (12) and (16), the real gradient of J can be assembled with respect to the composite real coefficient vector (35) as follows:

$$∇ ( J ) ≡ {[ \frac{\partial J}{\partial {a}^{rT}} \frac{\partial J}{\partial {a}^{iT}} \frac{\partial J}{\partial {b}^{rT}} \frac{\partial J}{\partial {b}^{iT}} ]}^{T} = {[ \frac{\partial J}{\partial {a}^{T}} \frac{\partial J}{\partial {b}^{T}} ]}^{T} . \qquad ( 37 )$$

Finally, with the above definitions, the Newton algorithm is written as
w(n+1)=w(n)−μH⁻¹∇(J). (38)

Generally, it has been observed that with the Newton algorithm, the error converges more quickly and steadily to zero, relative to the LMS algorithm which takes a longer time to converge completely. Even for 10% initialization with the Newton algorithm, convergence to zero was rapidly attained, although there may be some potential instability at some intermediate point.

In one variation, the capability of the Newton algorithm is extended by first running the LMS algorithm for a small number of samples and then using the coefficient values to initialize the Newton algorithm. It is noted that both the LMS and Newton algorithms are susceptible to getting stuck in a local minimum. The theoretical basis for this phenomenon is related to the nature of the MSE gradient, which for the all-pass structure turns out to have components that only differ by a function that depends on the coefficient value. Therefore, if any two coefficients ever reach the same value they will remain locked together, thereby leading to the local minimum. One way around this problem is to compute multiple solutions starting with a suitable number of initial guesses spaced out over the feasible parameter space.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks such as DVD, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer readable code means is any mechanism for allowing a computer to read instructions and data, such as magnetic variations on a magnetic media or height variations on the surface of a compact disk, such as a DVD.

It is to be understood that the embodiments and variations shown and described herein are merely illustrative of the principles of this invention and that various modifications may be implemented by those skilled in the art without departing from the scope and spirit of the invention.

1. A method for compensating for polarization mode dispersion in an optical fiber communication system, comprising the steps of:
reducing said polarization mode dispersion using a cascade of all-pass filters; and
adjusting coefficients of said all-pass filters using a least mean square algorithm.

2. The method of claim 1, wherein said cascade of all-pass filters comprises a two-channel structure consisting of multiple cascades of all-pass filters and directional couplers.

3. The method of claim 1, wherein said coefficient values are adjusted to minimize a cost function.

4. The method of claim 1, further comprising the step of measuring said polarization mode dispersion in a received optical signal.

5. The method of claim 4, wherein said measuring step employs a tunable narrowband optical filter to render information from energy detector measurements.

6. The method of claim 1, wherein said least mean square algorithm adjusts said coefficients as follows:
w(n+1)=w(n)−μ∇(J),
where w is a composite coefficient vector defined as:
$$w = [ \begin{matrix}a \\ b\end{matrix} ] , ∇ ( J ) ≡ {[ \frac{\partial J}{\partial {a}^{T}} \frac{\partial J}{\partial {b}^{T}} ]}^{T}$$
is the (P+Q)×1 complex gradient of J with respect to w, and
$$\frac{\partial J}{\partial {a}^{T}} ≡ [ \frac{\partial J}{\partial {a}_{1}} \frac{\partial J}{\partial {a}_{2}} ⋯ \frac{\partial J}{\partial {a}_{P}} ] , and \frac{\partial J}{\partial {b}^{T}} ≡ [ \frac{\partial J}{\partial {b}_{1}} \frac{\partial J}{\partial {b}_{2}} ⋯ \frac{\partial J}{\partial {b}_{Q}} ] .$$

7. A method for compensating for polarization mode dispersion in an optical fiber communication system, comprising the steps of:
reducing said polarization mode dispersion using a cascade of all-pass filters; and
adjusting coefficients of said all-pass filters using a Newton algorithm.

8. The method of claim 7, wherein said cascade of all-pass filters comprises a two-channel structure consisting of multiple cascades of all-pass filters and directional couplers.

9. The method of claim 7, wherein said coefficient values are adjusted to minimize a cost function.

10. The method of claim 7, further comprising the step of measuring said polarization mode dispersion in a received optical signal.

11. The method of claim 10, wherein said measuring step employs a tunable narrowband optical filter to render information from energy detector measurements.

12. The method of claim 7, wherein said Newton algorithm adjusts said coefficients as follows:
w(n+1)=w(n)−μH⁻¹∇(J)
where w is a composite coefficient vector defined as:
$$w = [ \begin{matrix}a \\ b\end{matrix} ] , ∇ ( J ) ≡ {[ \frac{\partial J}{\partial {a}^{T}} \frac{\partial J}{\partial {b}^{T}} ]}^{T}$$
$$\frac{\partial J}{\partial {a}^{T}} ≡ [ \frac{\partial J}{\partial {a}_{1}} \frac{\partial J}{\partial {a}_{2}} ⋯ \frac{\partial J}{\partial {a}_{P}} ] ,$$
is the (P+Q)×1 complex gradient of J with respect to w, a Hessian matrix, H, is defined as follows:
$$H = \frac{{\partial }^{2} J}{\partial w \partial {w}^{T}} = [ \begin{matrix}\frac{{\partial }^{2} J}{\partial a \partial {a}^{T}} & \frac{{\partial }^{2} J}{\partial a \partial {b}^{T}} \\ \frac{{\partial }^{2} J}{\partial b \partial {a}^{T}} & \frac{{\partial }^{2} J}{\partial b \partial {b}^{T}}\end{matrix} ] and$$
$$\frac{\partial J}{\partial {b}^{T}} ≡ [ \frac{\partial J}{\partial {b}_{1}} \frac{\partial J}{\partial {b}_{2}} ⋯ \frac{\partial J}{\partial {b}_{Q}} ] .$$

13. A polarization mode dispersion compensator in an optical fiber communication system, comprising:
a cascade of all-pass filters having coefficients that are adjusted using a least mean square algorithm.

14. The polarization mode dispersion compensator of claim 13, wherein said cascade of all-pass filters comprises a two-channel structure consisting of multiple cascades of all-pass filters and directional couplers.

15. The polarization mode dispersion compensator of claim 13, wherein said coefficient values are adjusted to minimize a cost function.

16. The polarization mode dispersion compensator of claim 13, further comprising the step of measuring said polarization mode dispersion in a received optical signal.

17. The polarization mode dispersion compensator of claim 16, wherein said measuring step employs a tunable narrowband optical filter to render information from energy detector measurements.

18. A polarization mode dispersion compensator in an optical fiber communication system, comprising:
a cascade of all-pass filters having coefficients that are adjusted using a Newton algorithm.

19. The polarization mode dispersion compensator of claim 18, wherein said cascade of all-pass filters comprises a two-channel structure consisting of multiple cascades of all-pass filters and directional couplers.

20. The polarization mode dispersion compensator of claim 18, wherein said coefficient values are adjusted to minimize a cost function.

21. The polarization mode dispersion compensator of claim 18, further comprising the step of measuring said polarization mode dispersion in a received optical signal.

22. The polarization mode dispersion compensator of claim 21, wherein said measuring step employs a tunable narrowband optical filter to render information from energy detector measurements.
